(19) United States
(12) Patent Application Publication
(10) Pub. No.: US 2025/0370682 A1
(43) Pub. Date: Dec. 4, 2025

(54) METHODS AND PRINTING SYSTEM FOR MANAGING OPERATIONS AT A PRINTING DEVICE

(71) Applicant: Kyocera Document Solutions Inc., Osaka (JP)

(72) Inventors: Javier A. MORALES, Rochester, NY (US); Timothy F. DONAHUE, Mentor, NY (US)

(73) Assignee: Kyocera Document Solutions Inc., Osaka (JP)

(21) Appl. No.: 19/219,524

(22) Filed: May 27, 2025

Related U.S. Application Data
(60) Provisional application No. 63/652,515, filed on May 28, 2024.

(51) Int. Cl. G06F 3/12

(52) U.S. Cl. CPC G06F 3/1287; G06F 3/1206; G06F 3/1236; G06F 3/1246

(57) ABSTRACT

A printing system includes a third party system and a printing device. The printing device includes a digital front end (DFE) that processes jobs and collects information about the printing device. The third party system sends a payload, such as a message or command, to the DFE over connection having a specified communication protocol. The DFE applies an interface having a transform to the payload to convert the information of the payload into a format useable by the DFE.

### FIELD OF THE INVENTION

The present invention relates to a printing system and associated methods to manage operations by enabling customization of interfaces without the need to customize the software at the printing device.

### DESCRIPTION OF THE RELATED ART

In order to enable efficient production, commercial printing devices integrate devices into their existing workflows and other management systems. This integration may be done in a variety of ways. For example, it may be done by leveraging existing integration between two vendor's products. This feature may require that the vendors integrate their products and maintain this integration as both products evolve. This aspect works as long as both vendors see value in maintaining the integration. This may not happen as these integrations are seldom of primary importance of either vendor.

The integration also may be done by leveraging configurability in the upstream products. Management information systems (MIS) and similar systems offer templating capabilities that enable mapping of variables from job information into a predefined document template. This feature may work, but the scope of integration is limited to adding variable values to templates, which has limited flexibility in the structuring of the templates. Templates are used to generate files that are unidirectionally submitted to downstream systems.

By leveraging import functionality in upstream products, MIS and similar systems offer file parsing and import functionality that allows retrieval of specific variable values from files saved into a hot folder. Integration also may be implemented using product customization. Customers may contract to have a one-off customization to enable vendor to vendor integration. This implementation may work but may make upgrades difficult, if not impossible. The vendor implements the customization anew to accommodate most software upgrades to either system.

### SUMMARY OF THE INVENTION

A method for managing operations at a printing device. The method includes receiving a command at a digital front end (DFE) of a printing device over a connection having a specified protocol. The command requests that the printing device performs an action. The method also includes intercepting the command within the DFE. The method also includes applying a first transform to the command to generate instructions to the DFE. The instructions are in a format understandable by the DFE. The method also includes performing the action at the printing device based on the instructions.

A printing device is disclosed. The printing device includes a processor and a memory connected to the processor. The memory stores instructions that, when executed on the processor, configures the printing device to perform the operations of receiving a command at a digital front end (DFE) of the printing device over a connection having a specified protocol. The command requests that the printing device performs an action. The operations further include intercepting the command within the DFE. The operations further include applying a first transform to the command to generate instructions to the DFE. The operations further include performing the action at the printing device based on the instructions.

An article of manufacture including a tangible, non-transitory computer-readable storage medium having instructions stored thereon that, in response to execution by a processor, configures the processor to perform operations including receiving a command at a digital front end (DFE) of a printing device over a connection having a specified protocol. The command requests that the printing device performs an action. The operations also include intercepting the command within the DFE. The operations also include applying a first transform to the command to generate instructions to the DFE. The instructions are in a format understandable by the DFE. The operations also include performing the action at the printing device based on the instructions.

### BRIEF DESCRIPTION OF THE DRAWINGS

Various other features and attendant advantages of the present invention will be more fully appreciated when considered in conjunction with the accompanying drawings.

FIG. 1A illustrates a printing system for managing jobs according to the disclosed embodiments.

FIG. 1B illustrates a block diagram of a digital front end of a printing device according to the disclosed embodiments.

FIG. 2 illustrates a block diagram of components of the printing device for use within the printing system according to the disclosed embodiments.

FIG. 3 illustrates a block diagram of an integrated printing system according to the disclosed embodiments.

FIG. 4 illustrates an integrated printing system having multiple interfaces and transforms according to the disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims.

The disclosed embodiments provide a printing system that enables customization of DFE interfaces without customization of the software in the DFE of the printing device. Customization may be implemented accordingly by different parties. Interfaces to the printing system are enhanced to perform inline transformation. For example, rather than process HyperText Transfer Protocol (HTTP) methods, such as GET, PUT, POST, and the like. The printing system would intercept the method, apply a transform to the payload of the method, and then perform the method with the updated payload.

Different transforms may be applied to different payload types. If the HTTP method payload is an XML file, then the disclosed embodiments may apply an XML Stylesheet Transform (XSLT). If the HTTP method payload is a JSON file, then the disclosed embodiments may apply a JSON transform. Similarly, before returning a response based to an HTTP method, the disclosed embodiments would first apply another transform to the XML or JSON response. The HTTP response would include output from the transformation. The transforms would be payload specific.

In order to enable interface customization, the XML Stylesheet and JSON transform files are stored in a location that is accessible to operators. The disclosed embodiments may have two sets of transform files. One set is an inbound set that is applied to payloads received via HTTP methods and an outbound set that is applied to the payload for responses to the HTTP methods.

To further facilitate customization, the printing system optionally may have a set of transform files for each supported inbound message and response. This feature would allow operators to modify inbound and outbound payloads for individual messages without having to encode logic to identify messages into the generic transform files. To facilitate integration with a variety of systems, the printing system optionally may have a set of transforms for individual clients. This feature would allow operators to modify inbound and outbound payloads for specific systems without having to encode the logic to identify specific clients into the generic transform files.

In addition, the disclosed embodiments may allow operators to define transforms that are applied to specific URLs. DFEs often have multiple queues, with each queue being available via a unique URL. The disclosed embodiments provide URL-specific transforms to allow customization for specific endpoints.

In order to customize an interface, operators need only to modify the inbound and outbound transforms interface for that system. This feature does not require changes to the software itself and may be done by end users or by professional service teams. The transforms, once in place, effectively modify the inbound and outbound interface for the systems. The modification may be global or it may be bounded in scope based on the above.

In order to enable testing and debugging, the printing system may have a “debug” option. When this option is enabled, the raw HTTP methods and payloads are stored before and after the transforms are applied. The messages are processed as expected but they do not actually have any effect on the system. Any actions that are taken as a result of a command received when debug is enabled are immediately rolled back after the responses are generated. This feature allows incremental development without introducing errors or invalid data into the system.

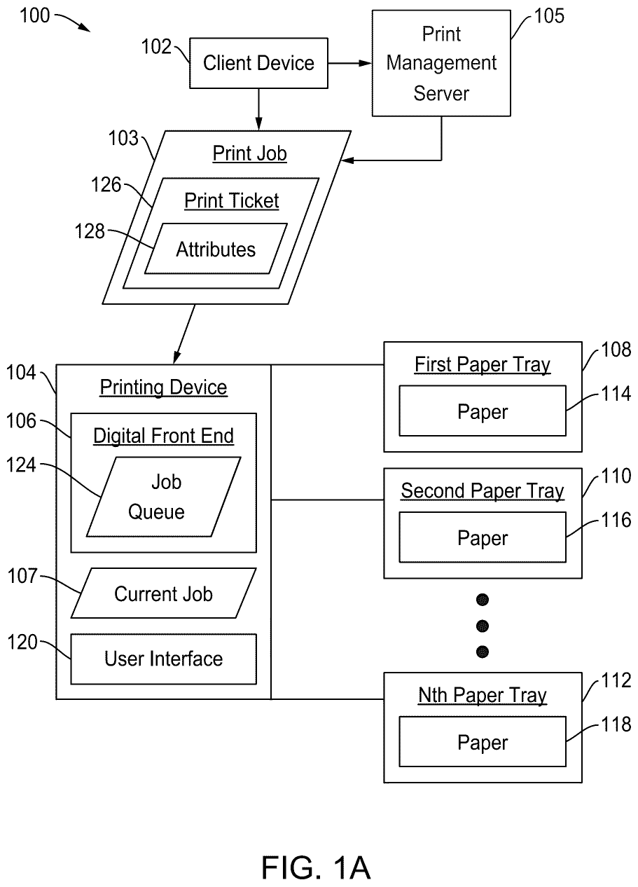

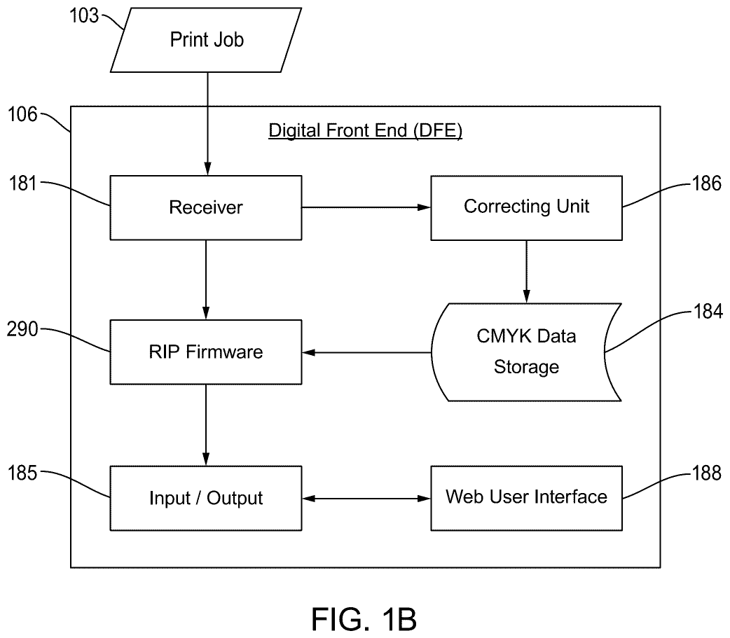

FIG. 1A depicts a printing system 100 for printing documents according to the disclosed embodiments. Printing system 100 includes printing device 104. Printing device 104 is disclosed in greater detail below. Printing device 104 may receive one or more print jobs 103 within printing system 100. For example, client device 102 may generate and send print job 103 to printing device 104. In some embodiments, printing device 104 may be a production printing device in that print jobs are provided through client device 102, which is attached to the printing device. Such a print job may require 1000s of pages or even 100,000 pages or more. A print management server 105 also may help with managing printing operations within system 100.

Print job 103 may include a print ticket 126 that sets forth one or more attributes, or parameters, 128 for the print job. For example, print ticket 126 may specify a size for a sheet of print job 103 as well as weight, quality of paper, color of paper, punched holes, and the like. The operator may generate print ticket 126 when submitting print job 103 for printing within printing system 100. Information from print ticket 126, such as one or more attributes 128, may be used to generate a production time to complete printing operations for print job 103.

Printing device 104 may receive print job 103 as it is processing and printing current job 107. Current job 107 may use different paper or media than print job 103. As such, printing device 104 may include a plurality of paper trays to supply papers of various types, sizes, weights, and the like. Thus, printing device 104 includes first paper tray 108 having paper 114, second paper tray 110 having paper 116, and so on to Nth paper tray 112 having paper 118. Current job 107 may use paper from one or more of these paper trays. In some embodiments, paper 114, paper 116, and paper 118 are different types of paper or different media. For example, current job 107 may use paper 116 from second paper tray 110 while print job 103 may require paper 114 from first paper tray 108.

User interface 120 may be in operations panel 208, disclosed below, or part of digital front end (DFE) 106. DFE 106 is disclosed in greater detail below. DFE 106 may process print jobs and act as a controller for printing device 104. Alternatively, user interface 120 may be displayed on client device 102. The disclosed embodiments may use user interface 120 to select papers for print job 103. Further, user interface 120 may display a calendar of print jobs as they are printing at printing device 104. This calendar may include different views depending on parameters for one or more print jobs at printing device 104.

DFE 106 also includes print job queue 124. Job queue 124 may be a register that includes print jobs 103 that are waiting to be sent to print engine 260, disclosed below. In some embodiments, DFE 106 may include more than one job queue 124. The different job queues may be based on some criterion such as urgent jobs or jobs requiring special finishing or some other operation. Print jobs in job queue 124 may be assigned a status. For example, print jobs within job queue 124 may be designated as being received, parsed, rendered, printed, or already printed. Job queue 124 is a local queue in that it resides in DFE 106.

FIG. 1B depicts a block diagram of DFE 106 according to the disclosed embodiments. DFE 106 includes a receiver 181, a RIP firmware 290, a CMYK data storage 184, an input/output connector 185, and a correcting unit 186. Additional components within DFE 106 may be implemented, as disclosed above and below. For example, although job queue 124 is not shown in FIG. 1B, it is part of DFE 106.

Receiver 181 receives print job 103 received within system 100 and outputs the print job to RIP firmware 290. In some embodiments, receiver 181 receives print job 103 from job queue 124. Receiver 181 also may receive color information for the document or documents within the print job. It may output the color information to correcting unit 186. The print job received by receiver 181 is associated with image data to be printed on print media. It also may include print condition information including information for indicating single-sided printing or two-sided printing or print medium-type information along with other data associated with the print job.

RIP firmware 290 converts image data associated with the print job into raster data to thereby generate rendering data, and outputs the generated rendering data. RIP firmware 290 also converts the rendering data into rendering data in a CMYK format. When the rendering data is originally in the CMYK format, or CMYK rendering data, the conversion may not be performed. RIP firmware 290 may perform gradation conversion of the CMYK rendering data, with reference to one or more tone reproduction curves (TRCs). A TRC refers to data indicating the relationship between a colored gradation value for rendering data and print color, or print density, on a given print medium.

When a print color alters over time, the TRCs stored in CMYK data storage 184 may be each deviated from an actually measured relationship between a colored value and print color. When the TRC is shifted from the actual relationship, gradation conversion for each colored gradation value cannot match a desired print color. In this regard, correcting unit 186 corrects the deviation, from the actual relationship, of the TRC stored in CMYK data storage 184 in order to allow each colored gradation value to match a desired print color. Correcting unit 186 converts RGB color information obtained through receiver 181 into CMYK color information. Correcting unit 186 may use the converted CMYK color information to generate the TRC. The TRC stored in CMYK data storage 184 is replaced with the generated TRC. Correcting unit 186 may correct the TRC. Correcting unit 186 may rewrite a part of the TRC stored in CMYK data storage 184 to thereby correct the TRC.

The rendering data generated by RIP firmware 290 may be transmitted within printing system 100 via input/output connector 185. The print condition information and the print medium type, as well as the rendering data, may be transmitted to a selected printing device within printing system 100. As disclosed above, the rendered data may be in a file format acceptable for a printing device such that the print job is provided directly to the print engine of the printing device.

DFE 106 also includes web user interface 188 that may communicate with other devices within printing system 100, if it is located at a separate device, using, for example, input/output connector 185. Web user interface 188, or web application, allows a user of the DFEs of other printing devices to interact with content or software running on DFE 106.

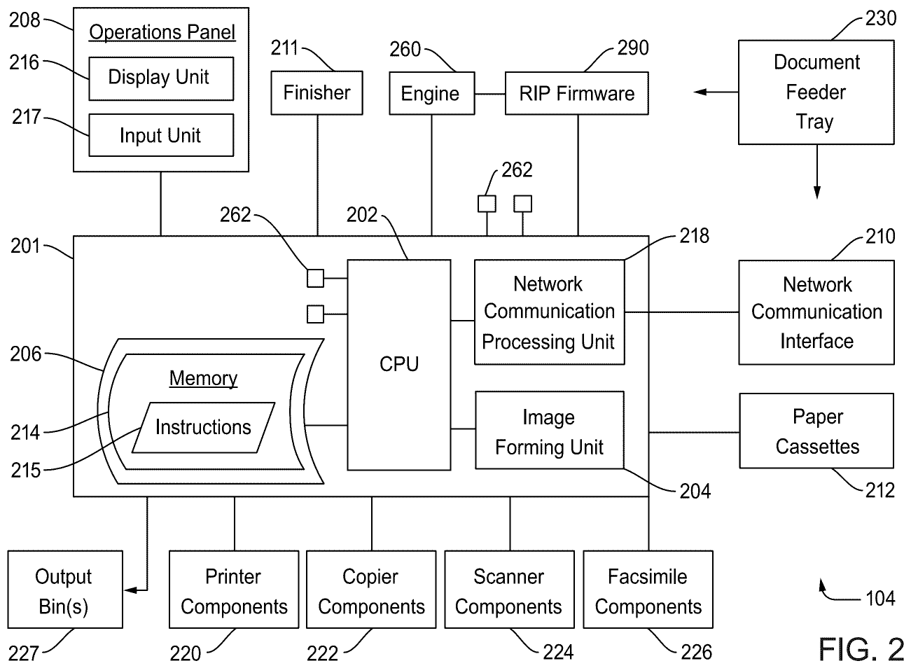

FIG. 2 depicts a block diagram of components of printing device 104 according to the disclosed embodiments. The architecture shown in FIG. 2 may apply to any multi-functional printing device or image forming apparatus that performs various functions, such as printing, scanning, storing, copying, and the like within system 100. As disclosed above, printing device 104 may send and receive data from DFE 106 and other devices within system 100.

Printing device 104 includes a computing platform 201 that performs operations to support these functions. Computing platform 201 includes a computer processing unit (CPU) 202, an image forming unit 204, a memory unit 206, and a network communication interface 210. Other components may be included but are not shown for brevity. Printing device 104, using computing platform 201, may be configured to perform various operations, such as scanning, copying, printing, receiving or sending a facsimile, or document processing. As such, printing device 104 may be a printing device or a multi-function peripheral including a scanner, and one or more functions of a copier, a facsimile device, and a printer. To provide these functions, printing device 104 includes printer components 220 to perform printing operations, copier components 222 to perform copying operations, scanner components 224 to perform scanning operations, and facsimile components 226 to receive and send facsimile documents. CPU 202 may issue instructions to these components to perform the desired operations.

Printing device 104 also includes a finisher 211 and one or more paper cassettes 212. Finisher 211 includes rotatable downstream rollers to move papers with an image formed surface after the desired operation to a tray. Finisher 211 also may perform additional actions, such as sorting the finished papers, binding sheets of papers with staples, doubling, creasing, punching holes, folding, and the like.

Paper cassettes 212 supply paper to various components 220, 222, 224, and 226 to create the image formed surfaces on the papers. Paper cassettes 212 also may be known as paper trays, shown as paper trays 108, 110, and 112 in FIG. 1A. Paper cassettes 212 may include papers having various sizes, colors, composition, and the like. Papers or media within paper cassettes 212 may be considered “loaded” onto printing device 104. The information for printing these papers may be captured in a paper catalog stored at DFE 106. Paper cassettes 212 may be removed to refill as needed. The printed papers from components 220, 222, 224, and 226 are placed within one or more output bins 227. One or more output bins 227 may have an associated capacity to receive finished print jobs before it must be emptied or printing paused. The output bins may include one or more output trays.

Document processor input feeder tray 230 may include the physical components of printing device 104 to receive papers and documents to be processed. Feeder tray also may refer to one or more input trays for printing device 104. A document is placed on or in document processor input feeder tray 230, which moves the document to other components within printing device 104. The movement of the document from document processor input feeder tray 230 may be controlled by the instructions input by the user. For example, the document may move to a scanner flatbed for scanning operations. Thus, document processor input feeder tray 230 provides the document to scanner components 224. As shown in FIG. 2, document processor input feeder tray 230 may interact with print engine 260 to perform the desired operations.

Memory unit 206 includes memory storage locations 214 to store instructions 215. Instructions 215 are executable on CPU 202 or other processors associated with printing device 104, such as any processors within components 220, 222, 224, or 226. Memory unit 206 also may store information for various programs and applications, as well as data specific to printing device 104. For example, a storage location 214 may include data for running an operating system executed by computing platform 201 to support the components within printing device 104. According to the disclosed embodiments, memory unit 206 may store the tokens and codes used in performing the deferral operations for printing device 104.

Memory unit 206 may comprise volatile and non-volatile memory. Volatile memory may include random access memory (RAM). Examples of non-volatile memory may include read-only memory (ROM), flash memory, electrically erasable programmable read-only memory (EEPROM), digital tape, a hard disk drive (HDD), or a solid-state drive (SSD). Memory unit 206 also includes any combination of readable or writable volatile memories or non-volatile memories, along with other possible memory devices.

Computing platform 201 may host one or more processors, such as CPU 202. These processors are capable of executing instructions 215 stored at one or more storage locations 214. By executing these instructions, the processors cause printing device 104 to perform various operations. The processors also may incorporate processing units for specific purposes, such as application-specific integrated circuits (ASICs) and field programmable gate arrays (FPGAs). Other processors may be included for executing operations particular to components 220, 222, 224, and 226. In other words, the particular processors may cause printing device 104 to act as a printer, copier, scanner, and a facsimile device.

Printing device 104 also includes an operations panel 208, which may be connected to computing platform 201. Operations panel 208 may include a display unit 216 and an input unit 217 for facilitating interaction with a user to provide commands to printing device 104. Display unit 216 may be any electronic video display, such as a liquid crystal display (LCD). Input unit 217 may include any combination of devices that allow users to input information into operations panel 208, such as buttons, a touch screen, a keyboard or keypad, switches, dials, and the like. Preferably, input unit 217 includes a touch-screen digitizer overlaid onto display unit 216 that senses touch to receive inputs from the user. By this manner, the user interacts with display unit 216. Using these components, one may enter codes or other information into printing device 104.

Display unit 216 also may serve as to display results from DFE 106, if applicable. DFE 106 may send calibration and paper catalog information to printing device 104 for display. For example, the operator at DFE 106 may send a calibration to printing device 104. Printing device 104 displays paper type and any other information needed to complete the calibration.

Printing device 104 also includes network communication processing unit 218. Network communication processing unit 218 may establish a network communication using network communication interface 210, such as a wireless or wired connection with one or more other image forming apparatuses or a network service. CPU 202 may instruct network communication processing unit 218 to transmit or retrieve information over a network using network communication interface 210. As data is received at computing platform 201 over a network, network communication processing unit 218 decodes the incoming packets and delivers them to CPU 202. CPU 202 may act accordingly by causing operations to occur on printing device 104. CPU 202 also may retrieve information stored in memory unit 206, such as settings for printing device 104.

Printing device 104 also includes print engine 260, as disclosed above. Engine 260 may be a combination of hardware, firmware, or software components that act accordingly to accomplish a task. For example, engine 260 is comprised of the components and software to print a document. It may receive instructions from computing platform 201 after user input via operations panel 208. Alternatively, engine 260 may receive instructions from other attached or linked devices.

Engine 260 manages and operates the low-level mechanism of the printing device engine, such as hardware components that actuate placement of ink or toner onto paper. Engine 260 may manage and coordinate the half-toner, toner cartridges, rollers, schedulers, storage, input/output operations, and the like. Raster image processor (RIP) firmware 290 that interprets the page description languages (PDLs) would transmit and send instructions down to the lower-level engine 260 for actual rendering of an image and application of the ink onto paper during operations on printing device 104.

Printing device 104 may include one or more sensors 262 that collect data and information to provide to computing platform 201 or CPU 202. Each sensor 262 may be used to monitor certain operating conditions of printing device 104. Sensors 262 may be used to indicate a location of a paper jam, failure of hardware or software components, broken parts, operating system problems, document miss-feed, toner level, as well as other operating conditions. Sensors 262 also may detect the number of pages printed or processed by printing device 104. When a sensor 262 detects an operational issue or failure event, it may send a signal to CPU 202. CPU 202 may generate an error alert associated with the problem. The error alert may include an error code.

Some errors have hardware-related causes. For example, if a failure occurred in finisher 211, such as a paper jam, display unit 216 may display information about the error and the location of the failure event, or the finisher. In the instance when the paper jam occurs in paper cassettes 212, display unit 216 displays the information about the jam error as located in one of the paper cassettes.

Some errors have a type of firmware-related cause. For example, network communication processing unit 218 may cause a firmware or software error. Display unit 216 may display the firmware-related error, any applicable error codes, and provide recommendations to address the error, such as reboot the device. Memory unit 206 may store the history of failure events and occurred errors with a timestamp of each error.

Printing device 104 communicates with other devices within system 100 via network communication interface 210 by utilizing a network protocol, such as the ones listed above. In some embodiments, printing device 104 communicates with other devices within system 100 through REST API, which allows the server to collect data from multiple devices within system 100. REST API and SOAP are application protocols used to submit data in different formats, such as files, XML messages, JSON messages, and the like. By utilizing applicable network communication protocols and application protocols, printing device 104 submits and receives data from DFE 106 as well as other devices within system 100.

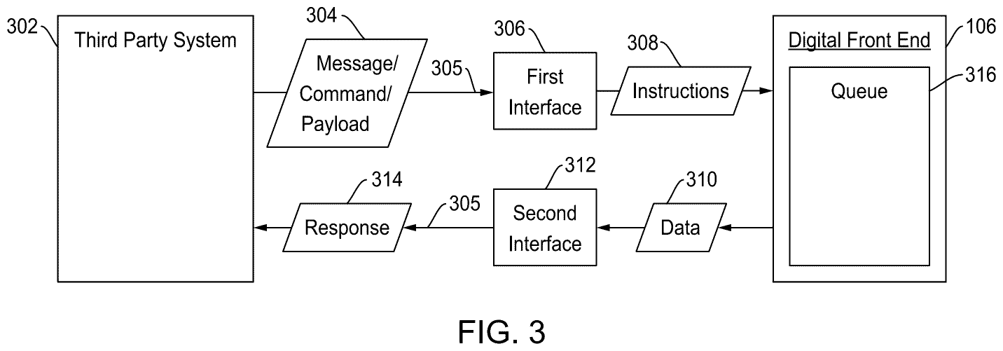

FIG. 3 depicts a block diagram of an integrated system according to the disclosed embodiments. The integrated system includes a third party system 302. Third party system 302 may include a MIS component or WF system. Third party system 302 may use a method, such as an HTTP method, to deliver payload 304. Payload 304 also may be known as a command or message. In addition to possibly being a print job, payload 304 may be a command supported by first interface 306.

For example, commands may include a command to get a list of jobs in queue 316 with information about the jobs, a command to get a list of jobs and their status, or a command to get information about printing device 104, such as configuration, resources, and statuses, and the like. First interface 306 also may include a mechanism to convert job settings in a print job of payload 304 from something provided by third party system 302 that is not understandable by DFE 106 into instructions 308 that are understandable.

Third party system 302 communicates over connection 305 to provide payload 304 to DFE 106. Connection 305 may have a specified protocol, such as HTTP. The protocol is a set of messages and responses in a specified format. First interface 306 corresponds to the protocol used by connection 305 to deliver messages to DFE 106.

The disclosed embodiments provide XJDF/XJMF support to allow a more robust and efficient system integration. The disclosed embodiments provide close integration between third party system 302 and printing device 104 to enable automation of operations, including printing operations. The disclosed embodiments also provide JDF/JMF support for industry-standard IDP ICS. The disclosed embodiments also provide seamless integration with detailed status and information. Status and detailed performance information, such as job costing information, ink estimation information, and the like, may be provided to the upstream system, such as third party system 302. Thus, third party system 302 may be provided information from printing device 104 over a connection having a communication protocol supported by the upstream system.

First interface 306 may include a transform that is customizable to transform payload 304, including commands and messages, into instructions 308 understandable by DFE 106. Instructions 308 may cause printing device 104 to perform an action, such as retrieve data in response to a command, as disclosed above. Instructions 308 also may cause DFE 106 to process a print job or other data within payload 304. Instructions 308 cause an action to be taken that generates data 310 as a result. For example, data 310 may be collected data in response to a command. It may be an acknowledgement that a print job is completed. Data 310 is provided to a second interface 312 that transforms the data into response 314 that is understandable by third party system 302 over connection 305 in the specified protocol.

Thus, first interface 306 and second interface 312 may sit between third party system 302 and DFE 106 of printing device 104 to transform incoming and outgoing messages over the specified protocol. First interface 306 may include a transform that modifies payload 304 to be understood by DFE 106. This transform may depend on the specified protocol used by connection 305. For example, if the HTTP method payload 304 is an XML file, then first interface 306 may apply an XML Stylesheet transform. This feature may allow first interface 306 to add and remove elements and attributes to and from payload 304. It also may rearrange and sort elements, perform tests, and make decisions about how to treat various elements. These options are configurable for each instance of a connection providing a payload, command, or message to DFE 106.

First interface 306 also may receive payload 304 as a JSON file such that first interface 306 applies a JSON transform. This transform may be used to slice, filter, map, and transform structured data. The transform may implement a command-line JSON processor within first interface 306.

Second interface 312 also includes one or more transforms to convert data 310 into a response 314 that is understandable by third party system 302. In some embodiments, each protocol connection may have its own interfaces. Further, separate interfaces may be used for each supported inbound payload 304 and response 314. This feature would allow operators to modify inbound payloads and outbound responses for individual messages without having to encode logic to identify messages into the generic transform files.

First interface 306 and second interface 312 may be stored at DFE 106 or within printing device 104. Further, the integrated system may include a debug option. Payload 304 may be stored before and after the transforms are applied by first interface 306 or second interface 312.

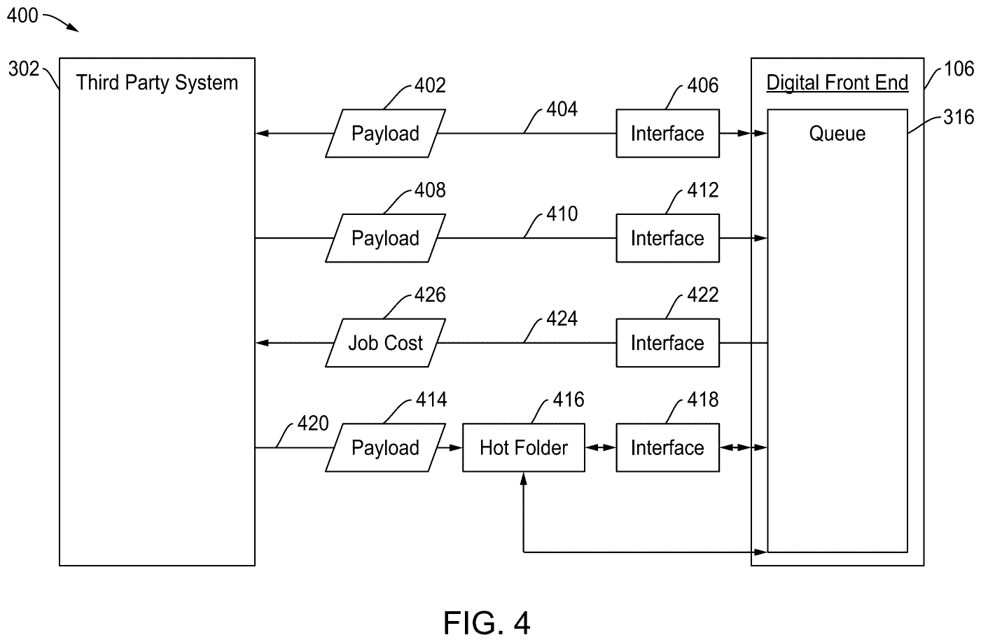

FIG. 4 depicts an integrated printing system 400 having multiple interfaces and transforms according to the disclosed embodiments. Connection 404 may provide support for JMF/JDF protocols. Payload 402 may be a JMF/JDF file that is received at interface 406. Interface 406 includes a transform that converts payload 402 into instructions understandable by DFE 106. For example, it may be converted and placed in queue 316.

Integrated printing system 400 also includes connection 410 that may provide support for XJDF/XJMF communications. Payload 408 may be a XJDF/XJMF file that is received by interface 412, which applies a different transform to generate instructions to DFE 106. Any number of connections may be supported with different interfaces. Further, different connections may be made to a plurality of queues within DFE 106 so that each connection to the different queues also includes interfaces.

In some embodiments, third party system 302 may copy payload 414 over connection 420 to hot folder 416. Interface 418 may sit between hot folder 416 and DFE 106 so that different files retrieved from hot folder 416 also are transformed. In other words, the payloads may not be received over a connection having a protocol but from another source that feeds jobs to printing device 104. In other embodiments, a storage device may receive payload 414, such as print management server 105, that also has jobs retrieved therefrom. An interface may be used to transform the payloads.

As noted above, a payload may include a command for information from printing device 104. Thus, connection 424 provides job costing information 426 to third party system 302. Interface 422 may be used to transform the data from DFE 106 into data useable by third party system 302. It should be noted that all interfaces disclosed in system 400 may include a first interface and a second interface as disclosed above.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

Embodiments may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more printing systems coupled to a network capable of exchanging information and data. Various functions and components of the printing system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

The invention claimed is:

1. A method for managing printing operations at a printing device, the method comprising:
receiving a command at a digital front end (DFE) of a printing device over a connection having a specified protocol, wherein the command requests that the printing device perform an action;
intercepting the command within the DFE;
applying a first transform to the command to generate instructions to the DFE, wherein the instructions are in a format understandable by the DFE; and
performing the action at the printing device based on the instructions.

2. The method of claim 1, wherein the specified protocol is a hypertext transfer protocol (HTTP).

3. The method of claim 1, wherein the transform relates to a specified uniform resource locator (URL).

4. The method of claim 1, further comprising generating data based on the action within the DFE.

5. The method of claim 4, further comprising intercepting the data from the DFE on the connection.

6. The method of claim 5, further comprising applying a second transform to the data generated by the action.

7. The method of claim 6, further comprising generating a response to the command using the second transform based on the data, wherein the response corresponds to the protocol of the connection.

8. The method of claim 7, further comprising sending the response over the connection from the DFE.

9. The method of claim 6, further comprising storing the first transform and the second transform at the DFE.

10. A printing device comprising:
a processor and a memory connected to the processor, wherein the memory stores instructions that, when executed on the processor, configures the printing device to perform the operations of
receiving a command at a digital front end (DFE) of a printing device over a connection having a specified protocol, wherein the command requests that the printing device perform an action;
intercepting the command within the DFE;
applying a first transform to the command to generate instructions to the DFE, wherein the instructions are in a format understandable by the DFE; and
performing the action at the printing device based on the instructions.

11. The printing device of claim 10, wherein the specified protocol is a hypertext transfer protocol (HTTP).

12. The printing device of claim 10, wherein the transform relates to a specified uniform resource locator (URL).

13. The printing device of claim 10, wherein the operations further comprise generating data based on the action within the DFE.

14. The printing device of claim 13, wherein the operations further comprise intercepting the data from the DFE on the connection.

15. The printing device of claim 14, wherein the operations further comprise applying a second transform to the data generated by the action.

16. The printing device of claim 15, wherein the operations further comprise generating a response to the command using the second transform based on the data, wherein the response corresponds to the protocol of the connection.

17. The printing device of claim 16, wherein the operations further comprise sending the response over the connection from the DFE.

18. The printing device of claim 15, wherein the operations further comprise storing the first transform and the second transform at the DFE.

19. An article of manufacture including a tangible, non-transitory computer-readable storage medium having instructions stored thereon that, in response to execution by a processor, configures the processor to perform operations comprising:
receiving a command at a digital front end (DFE) of a printing device over a connection having a specified protocol, wherein the command requests that the printing device perform an action;
intercepting the payload/message/command within the DFE;
applying a first transform to the command to generate instructions to the DFE, wherein the instructions are in a format understandable by the DFE; and
performing the action at the printing device based on the instructions.

20. The article of manufacture of claim 19, wherein the operations further comprise generating data based on the action within the DFE;
intercepting the data from the DFE on the connection;
applying a second transform to the data generated by the action;
generating a response to the command using the second transform based on the data, wherein the response corresponds to the protocol of the connection; and
sending the response over the connection from the DFE.
